(19) United States
(12) Patent Application Publication
(10) Pub. No.: US 2008/0075914 A1
(43) Pub. Date: Mar. 27, 2008

(54) METHOD OF MANUFACTURING A COLORED COMPOSITE LEATHER

(76) Inventor: Tian-Lai CHENG, Taichung City (TW)

Correspondence Address: LEONG C LEI, PMB # 1008, 1867 YGNACIO VALLEY ROAD, WALNUT CREEK, CA, 94598, US

(21) Appl. No.: 11/759,236

(22) Filed: Jun. 7, 2007

(30) Foreign Application Priority Data
Sep. 25, 2006 (TW) 095135308

(51) Int. Cl. B32B 33/00

(52) U.S. Cl. 428/95

(57) ABSTRACT

A method of manufacturing a colored composite leather is disclosed. The method comprises the steps of forming a transparent layer by injection; high frequency fusing, laminate by adhering the transparent layer with a colored thin film; comprising the transparent layer and the colored thin film such that the transparent layer and the colored thin layer form into a two-layered body; adhering the two layered onto the surface of the foam layer, and adhering a fabric layer to the product obtained in the two layered onto the surface of the foam layer, to form a colorful composite leather.

### BACKGROUND OF THE INVENTION

(a) Technical Field of the Invention

The present invention relates to colored composite leather, and in particular, to a method of manufacturing a colored composite leather.

(b) Description of the Prior Art

Conventional leathers are generally with ornamental threads, however, from aesthetic point of view, these threads designs is monotonous and does not attract trendy buyers.

With the development of technology the cost of manufacturing of leather is greatly reduced and therefore artificial leathers are widely sold around the world. But the conventional methods have the following drawbacks.
1. After a period of use of the leather, the printed design or colors will fade or disappear.
2. Silk screen printing is generally employed, thus, the resolution of the images and the quality of the prints are low, prints with 1 million pixels are seldom obtained.
3. The base color of the leather limits the color quality of the leather
4. Silk screen printing is comparative expensive and the rate of production is low.
5. Thermal transfer printing could be employed to obtain full color picture, but the process is complicated, and besides the cost of printing is high and the printed images will fade easily.

It is a main object of the present invention to provide a method of manufacturing a colored composite leather to mitigate the above drawbacks.

### SUMMARY OF THE INVENTION

The primary purpose of the present invention is to provide a method of manufacturing a colored composite leather comprising a transparent layer, a colored thin film layer, a foam layer and a fabric layer, the method comprising the steps of forming a transparent layer by extrusion or injection; high frequency fusing the transparent layer with a colored thin film; comprising the transparent layer and the colored thin film such that the transparent layer and the colored thin layer form into a two-layered body; adhering the two layered onto the surface of the foam layer, and adhering a fabric layer to the product obtained in the two layered onto the surface of the foam layer to form a composite leather.

Yet still another object of the present invention is to provide a method of manufacturing a colored composite leather wherein the colored thin film is a porous thin film material printed with images.

A further object of the present invention is to provide a method of manufacturing a colored composite leather wherein the porous thin film material includes papers, synthetic papers, fiber fabric, plastic thin films including polyethylene, polypropylene, PET, TPU, PVC, TPE blending with auxiliary materials.

Still a further object of the present invention is to provide a method of manufacturing a colored composite leather wherein the transparent layer materials is obtained from the blending of PVC, styrene-butadiene-styrene copolymer, styrene-isoprene-styrene copolymer, styrene-ethylene butylene styrene copolymer, styrene-ethylene propylene styrene copolymer, thermoplastic polyurethane, poly olefin elastomer, ethylene-propylene rubber, ethylene-propylene-diene rubber, butadiene rubber, solution-butadiene rubber, isoprene rubber, polyurethane rubber with an auxiliary material.

Yet still a further object of the present invention is to provide a method of manufacturing a colored composite leather wherein the foam material is polyurethane, ethylene vinyl acetate, thermoplastic elastomer, synthetic rubber, polyvinyl chloride and the relative weight is 0.05-1.50.

Yet a further object of the present invention is to provide a method of manufacturing a colored composite leather wherein the materials of fabric layer include non-woven cloth, nylon, polyester fabric, and the fabric layer is formed by stacking one or more than one layer of the materials.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the fabrication of porous thin film in accordance with the present invention.

FIG. 2 is a flowchart showing the combination of a transparent layer with a colored thin film in accordance with the present invention.

FIG. 3 is a flowchart showing the fabrication of a colored composite leather of the present invention.

FIG. 4 is a perspective view of the composite layer of the present invention.

FIG. 5 is another perspective view of the composite layer of the present invention.

FIG. 6 is a schematic view of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The colored composite leather of the present invention comprises a transparent layer, a color thin film, a foam layer and a fabric layer. The color images are formed between the foam layer and a transparent layer, and the method of fabrication of the color images includes the steps of (i) selecting a porous thin film (or porous material) as a printing body and the printed color film is adhered to a transparent layer as a body. The thickness of the body is ranging from 0.05-3.0 mm, and the body is adhered with a foam layer and a fabric layer, forming into a composite layer.

In accordance with the present invention, the porous thick films have physical adhesion force with polymers such as rubber, plastic resins, ink adhesive. The materials which could be used for printings include papers, synthetic papers, fiber fabric, plastic thin films including polyethylene, polypropylene, PET, TPU, PVC, TPE blending with auxiliary materials.

In the present invention, printing refers to laser printing, ink-jet printing. These types printings provide quality prints of more than 1 million pixels and the process of printing is fast.

The methods of combination of image layer and the transparent layer include:
1. By injection molding. A transparent material is injection into the colored thin layer to form a combined layer, or the first layer is a color layer, the second layer or the middle layer a porous color film and the bottom base layer is a transparent or a non-transparent layer, forming into a sandwiched structure.
2. High periodic wave method. Using a high periodic wave to fuse the transparent layer and the color layer to form a two layered or three layered structure.
3. By the method of extrusion. By the method of plate press or extrusion using a calendar device, the porous colored film and the transparent layer are fused to form a composite layer with color images. The structures can be two or three layers.
4. By the method of adhesion. A transparent layer is adhered onto a color thin film.

In accordance with the present invention, the transparent layers include: PVC, styrene-butadiene-styrene copolymer, styrene-isoprene-styrene copolymer, styrene-ethylene butylene styrene copolymer, styrene-ethylene propylene styrene copolymer, thermoplastic polyurethane, poly olefin elastomer, ethylene-propylene rubber, ethylene-propylene-diene rubber, butadiene rubber, solution-butadiene rubber, isoprene rubber, polyurethane rubber.

If the transparent layer has to be sulfurization, prior to forming into a composite layer, peroxides or cross-linked resin used as a bridging agent or cross-link agent is added. The peroxides include: dicumyl peroxide (DCP), Benzo peroxide (BPO), methyl ethyl ketone peroxide MEKPO, and the amount of additive is ranging from 0.1-8 phr (parts per hundred resins).

After the transparent layer and the colored thin film are combined together using the above-mentioned methods to form a single unit, it is mounted onto the surface at the upper section of the foam layer. The lower section of the foam layer is adhered onto a fabric layer, forming into a synthetic leather with a transparent layer in which the image at the inner layer could be seen.

The materials of the foam layer include PU (polyurethane), EVA (ethylene vinyl acetate) TPE (thermoplastic elastomer), conventional vulcanized rubber, polyvinylchloride (PVC). The relative weight is ranging from 0.05-1.50, and the fabric layer is formed by stacking at least one layer, for example, selected from non-woven fabric or nylon, polyester, and the fabric layer is attached to the bottom of the foam layer.

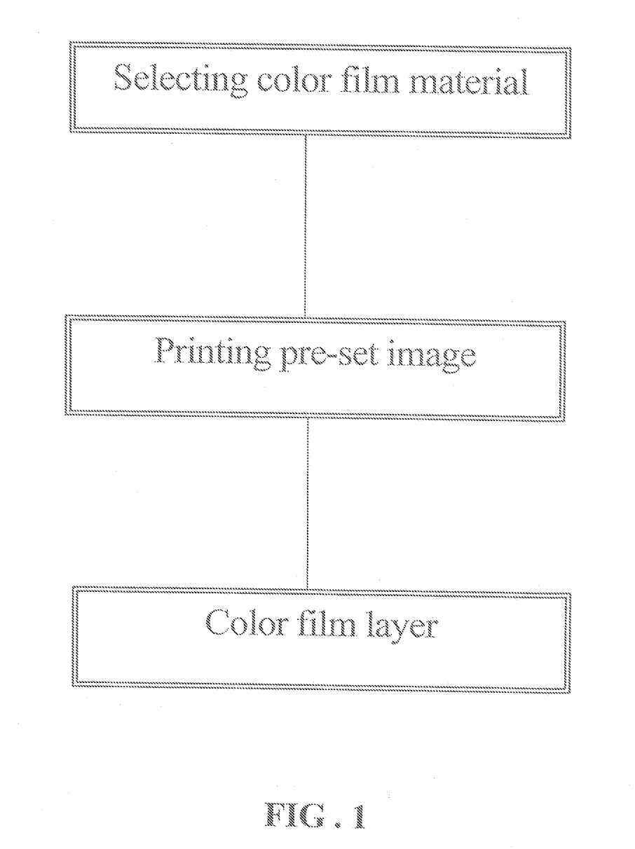

Referring to FIG. 1, there is shown a flowchart of manufacturing a colored thin-film in accordance with the present invention. A porous thin film material is selected and is then formed into a colored thin film. The term, “color thin film printing” is particularly referred to mass production printing using automatic printing device.

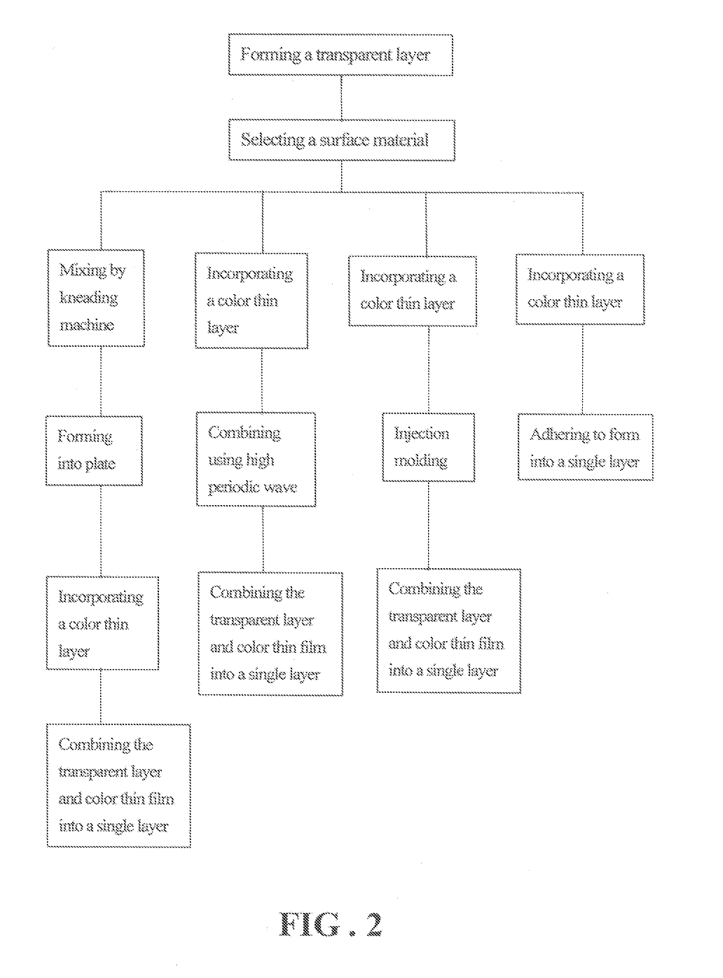

As shown in FIG. 2, which is a flowchart showing the formation of a composite body of the colored thin film and the transparent layer. The methods of formation are greatly depending on the material used. For instance, if injection molding is employed the printed colored thin film 20 is first placed into the injection mold, and after a plastic injection molding process, a transparent layer is directly covered onto the colored thin film, forming into a single unit.

In a second method of high periodical wave, PVC or TPU film is selected to be used as a transparent layer 10 material. Similarly, a colored film is added and by way of high periodic wave, the transparent layer and the colored thin film layer 20 are combined into a single body.

The third method of forming a composite layer is by mixing raw material and kneading device is used to form into a plate body, which is a plate formed from a transparent layer 10 together with a colored thin film 20 via a flat press device or extruding device. Upon compression, the transparent layer and a colored thin film are formed into a single unit.

A fourth fabrication method is by direct adhesion of a transparent layer 10 onto a colored thin film 20.

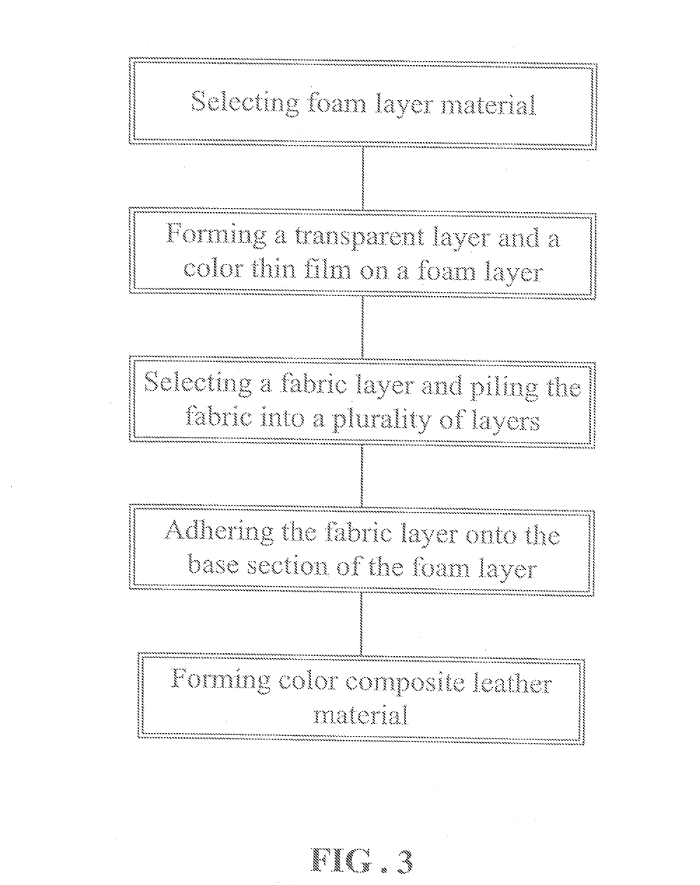

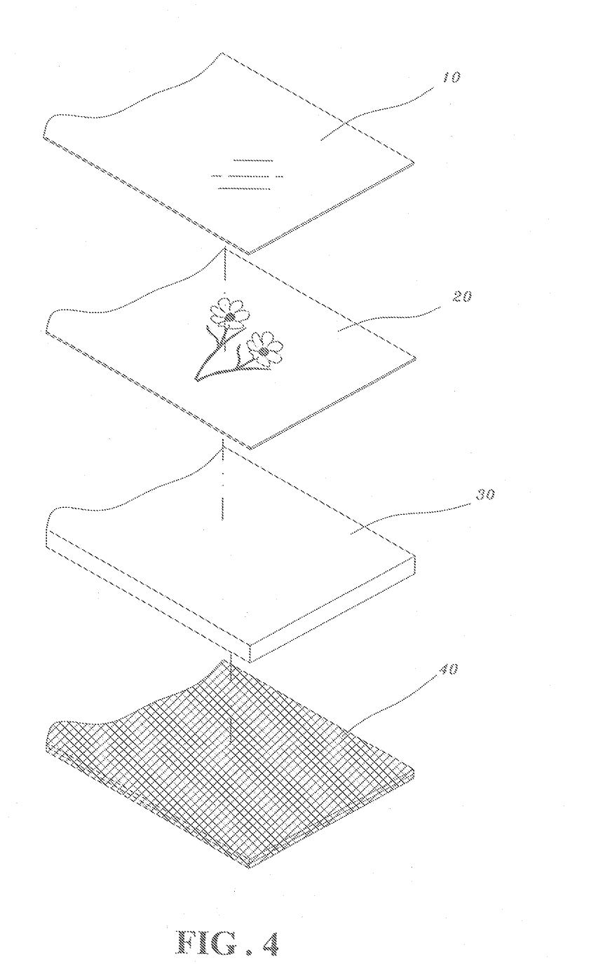

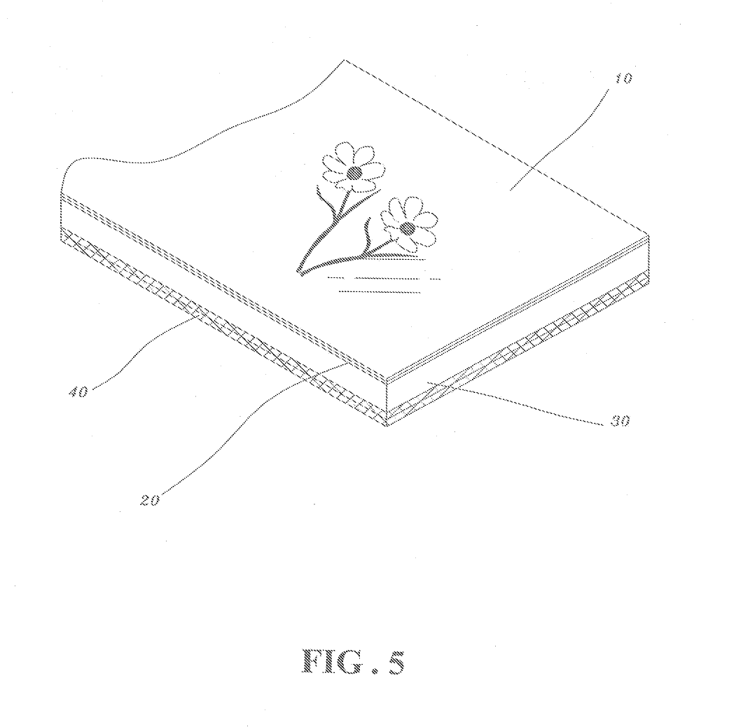

As shown in FIGS. 3 to 5, there is shown the formation into a single unit from a transparent layer 10 and a colored thin film employing methods 1 to 4 indicated in FIG. 2, which is adhered onto the surface of the foam layer. The bottom portion of the foam layer is adhered with a fabric layer 40 formed by stacking at least one cloth layer, forming into four-layered artificial leather. The structure of the artificial leather is shown in FIG. 5. The thickness of the combination of the transparent layer with the colored thin layer by the above four methods is ranging from 0.05-3.0 mm, which could be mounted onto the surface of the leather.

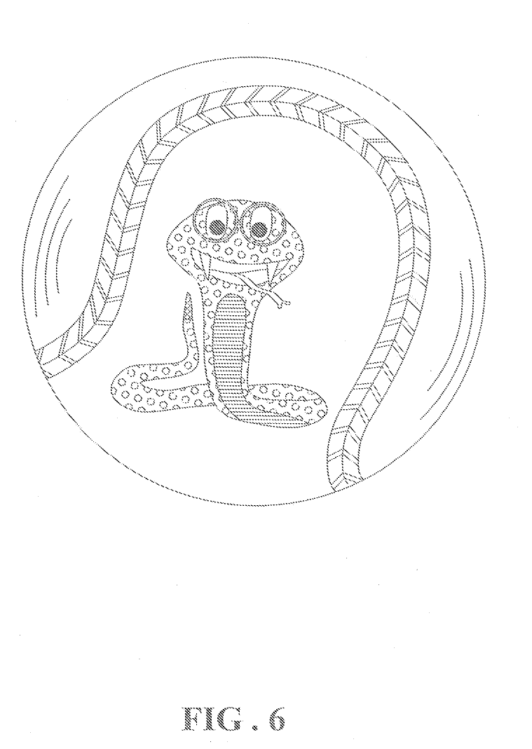

FIG. 6 is a schematic view showing a colored composite leather in accordance with the present invention. These composite materials are used in the manufacturing of balls, decorative items, of the surface of an article. The composite leather with color images being at the interior of the transparent layer, the color image will not be worn out. Accordingly the images protruded within the interior of the transparent layer are more diversified.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of manufacturing a colored composite leather comprising a transparent layer, a colored thin film layer, a foam layer and a fabric layer, the method comprising the steps of
forming a transparent layer by injection, extrusion laminate
high frequency fusing the transparent layer with a colored thin film;
comprising the transparent layer and the colored thin film such that the transparent layer and the colored thin layer form into a two-layered body;
adhering the two layered onto the surface of the foam layer, and
adhering a fabric layer to the product obtained in (d) to form a composite leather.

2. The method of claim 1, wherein the colored thin film is a porous thin film material printed with images.

3. The method of claim 1, wherein the porous thin film material includes papers, synthetic papers, fiber fabric, plastic thin films including polyethylene, polypropylene, PET, TPU, PVC, TPE blending with auxiliary materials.

4. The methods of claims 1, wherein the transparent layer materials is obtained from the blending of PVC, styrene-butadiene-styrene copolymer, styrene-isoprene-styrene copolymer, styrene-ethylene butylene styrene copolymer, styrene-ethylene propylene styrene copolymer, thermoplastic polyurethane, poly olefin elastomer, ethylene-propylene rubber, ethylene-propylene-diene rubber, butadiene rubber, solution-butadiene rubber, isoprene rubber, polyurethane rubber with an auxiliary material.

5. The methods of claims 2, wherein the transparent layer materials is obtained from the blending of PVC, styrene-butadiene-styrene copolymer, styrene-isoprene-styrene copolymer, styrene-ethylene butylene styrene copolymer, styrene-ethylene propylene styrene copolymer, thermoplastic polyurethane, poly olefin elastomer, ethylene-propylene rubber, ethylene-propylene-diene rubber, butadiene rubber, solution-butadiene rubber, isoprene rubber, polyurethane rubber with an auxiliary material.

6. The method of claim 1, wherein the foam material is polyurethane, ethylene vinyl acetate, thermoplastic elastomer, rubber, polyvinyl chloride and the relative weight is 0.05-1.50.

7. The method of claim 1, wherein the materials of fabric layer include non-woven cloth, nylon, polyester fabric, and the fabric layer is formed by stacking one or more than one layer of the materials.
